(19) United States
(12) Patent Application Publication
(10) Pub. No.: US 2017/0147743 A1
(43) Pub. Date: May 25, 2017

(54) RAPID IDENTIFICATION OF PHARMACOLOGICAL TARGETS AND ANTI-TARGETS FOR DRUG DISCOVERY AND REPURPOSING

(71) Applicant: UNIVERSITY OF MIAMI, Miami, FL (US)

(72) Inventors: John Bixby, Miami, FL (US); Vance Lemmon, Miami, FL (US); Hassan Al-Ali, Miami, FL (US)

(21) Appl. No.: 15/360,428

(22) Filed: Nov. 23, 2016

Related U.S. Application Data
(60) Provisional application No. 62/259,029, filed on Nov. 23, 2015.

(51) Int. Cl. G06F 19/12; G06F 19/22; G06F 19/24

(52) U.S. Cl. CPC G06F 19/12; G06F 19/24; G06F 19/22

(57) ABSTRACT

A computing system automatically analyzes various drug or other compound targets using biologic activity data for cellular proteins, and develops a target/anti-target matrix identifying pharmacologically responsive targets intended for drug engagement, and pharmacologically responsive anti-targets intended for avoidance of drug engagement. The system separates compounds into subsets based on biological threshold data and groups proteins through pharmacological similarity. The system ranks protein groupings in generating the matrix and uses the rankings to recommend compounds and compound groupings for testing to treat a pathology. The system compares new compounds against the matrix to recommend new compounds for testing.

### CROSS-REFERENCE TO RELATED APPLICATION

This application claims the benefit of U.S. Provisional Application No. 62/259,029, filed Nov. 23, 2015, entitled “Rapid Identification of Patient-Specific Drug Targets and Anti-Targets for Personalized Therapeutic Regimen,” which is hereby incorporated by reference in its entirety.

### STATEMENT REGARDING FEDERALLY SPONSORED RESEARCH OR DEVELOPMENT

This invention was made with government support under grant W81XWH-13-1-077 awarded by the Department of Defense, grant W81XWH-05-1-0061 awarded by the United States Army, and by grants HD057521 and NS059866 awarded by the National Institutes of Health. The Government has certain rights in the invention.

### FIELD OF THE DISCLOSURE

The present disclosure relates generally to techniques for classifying potential treatment compounds based on a model of biologic activity and, more particularly, to techniques classifying potential treatment compounds through the formation of a protein target and protein anti-target biological activity model.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Despite substantial advances in our understanding of disease biology and large investments in pharmaceutical research, the rate of new drugs making it to the market has remained largely unchanged. This suggests a need to reconsider the current drug discovery paradigms and their associated technologies.

At present, drug discovery is dominated by two competing approaches: target-based screening and phenotypic screening.

Target-based screening begins with the hypothesis that a particular gene product serves as an effective drug target for a given therapeutic application. The target is then biochemically assayed with millions of compounds to identify potent pharmacological modulators. As such, target-based screening is extremely efficient at identifying ligands for individual targets. However, target-based screening provides no information on the effect of those ligands (typically small-molecule compounds) on other therapeutic targets, harmful/counterproductive anti-targets, or whole cells. Moreover, it is becoming apparent that compounds that engage multiple therapeutic targets tend to make better drugs than compounds that very selectively engage a single therapeutic target. Additionally, many of the genes that are hypothesized, using genomic or transcriptomic analyses, to be good drug targets end up being either ineffective in the clinic or have turned out to be undruggable altogether.

In contrast to target-based screening, phenotypic screening tests compounds on cells (or tissue or animals), and therefore does not require a starting target hypothesis. As such, phenotypic screening can identify compounds that work through highly responsive targets without prior bias. More importantly, it is able to discover compounds that engage multiple targets (polypharmacology) to elicit strong therapeutic responses. This can be especially useful for complex polygenic disorders, or disorders where diseased cells can mutate, inactivate therapeutic drug targets, and rapidly evolve tolerance to classical treatments (e.g., cancer). Unfortunately, it is often difficult to identify the relevant target(s) from phenotypic screens. Such limitations render further optimization of lead compounds difficult, obstruct rational exploitation of polypharmacology, and provide little guidance for optimizing combinatorial treatments.

Another problem with present drug discovery is a lack of smart identification between target and anti-target drug engagement. The same drug that shows promise because of its targeting may engage undesired anti-targets, and it may be difficult to identify such engagement without substantial testing. Also, while anti-target (i.e., unwanted off-target) engagement can be deleterious, compounds with desirable polypharmacology (i.e., those that engage multiple therapeutic targets and do not engage major anti-targets) can manifest improved therapeutic efficacy, reduced toxicity, and lowered chance of tolerance/resistance.

To provide for smarter drug target and anti-target applications, kinases have been used. Kinases are attractive drug targets with broad therapeutic applications, and they are particularly suited for polypharmacology applications. A well-known example is Gleevec (imatinib mesylate), which was originally developed to hone in on a single kinase target but was later found to work by engaging at least two other targets. Since then, many other examples were identified. Indeed, some have recently credited polypharmacology for the efficacy of most approved drugs and suggested that hyper-selectivity may in fact be a drawback, given the robustness of biological networks. Thus, engaging multiple targets (avoiding multiple anti-targets) may now become a requirement for drug efficacy.

In any event, as a result, there is a desire to have systems and techniques for more quickly and more accurately identifying suitable targets and anti-targets of treatments for various phenotypes of a person, and in particular systems and techniques tailored to that person based on empirical data.

### SUMMARY OF THE INVENTION

Techniques are described for automating analysis of various drugs, or compounds, targets for treating patients to determine which treatments are more likely to be efficacious and which treatments which will not be, or which may be, in fact, more harmful to a patient's condition due to engaging anti-targets. The techniques are able to automatically examine a large number of available drug treatments, for example, and to assess which treatments are treatments that may be applied to the patient and which ones are not.

The present techniques are able to integrate the two predominant drug discovery technologies, target-based and phenotypic screening, combining their respective strengths through the use of information theory and machine learning.

In some examples, the present techniques prioritize a set of highly responsive drug targets (and anti-targets) and ultimately identify compounds that inhibit multiple candidate drug targets without inhibiting anti-targets. In doing so, the present techniques are able to simultaneously solve two hurdles for drug discovery: 1) how to efficiently identify targets from phenotypic screens, and 2) how to systematically discover drugs with multi-target activity. Further, as we show in the example of kinases, the present techniques have been shown to identify previously-neglected and previously-rejected targets and anti-targets, establishing an automated testing procedure that produces unexpected results that counter prevailing theories on testing and treatment. Last but not least, the method provides a platform for identifying novel drug targets amongst previously neglected or poorly studied kinases.

In accordance with an example, a computer-implemented method of classifying potential treatment compounds based on a model of biologic activity, the method comprises: receiving, at one or more processing units, biologic data on a set of testing compounds; identifying, at the one or more processing units, within the set of testing compounds, (i) a first subset of compounds that form an active compound class characterized by producing a desired biologic activity, and (ii) a second subset of compounds that form an inactive compound class characterized by producing no biologic activity or inhibiting the desired biologic activity; receiving, at the one or more processing units, protein biochemical activity data on the set of testing compounds; identifying, at the one or more processing units, a subset of proteins from a set of proteins, wherein the subset of proteins comprises proteins that correlate to the first set of compounds and/or the second subset of compounds; clustering, at the one or more processing units, the subset of proteins to form pharmacologically linked protein groups; ranking the pharmacologically linked protein groups based on an aggregated biological activity score; and producing, from the ranked pharmacologically linked protein groups, a protein target/anti-target biologic activity model, where the protein target/anti-target biologic activity model identifies protein target groups separately from protein anti-target groups, and where engagement of the protein targets promotes a biological activity and engagement of the protein anti-targets impedes the biological activity.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a flow diagram of a process for determining a target/anti-target biologic activity matrix, in an example.

FIG. 2 is a flow diagram of a detailed example of a target/anti-target biologic activity matrix generation, in an example.

FIG. 3A illustrates prioritized groups of kinases representing robust target and anti-target grouping for accurate prediction of compound biologic activity, in an example.

FIG. 3B illustrates a target-anti-target activity matrix generated by the techniques herein, in an example.

FIG. 4A illustrates examples of hits with favorable polypharmacology based on neurite outgrowth promotion serving as the biologic activity, identified by the techniques herein, in an example.

FIG. 4B illustrates a first compound (R00480500-002) that is determined, by the techniques herein, to have no chemical similarity to three other hits with analogous polypharmacology, in an example.

FIGS. 4C-4F illustrate delivery of R00480500-002 after pyramidotomy in mice promotes growth of uninjured corticospinal axons into the denervated contralateral gray matter. FIGS. 4D and 4F are magnified images represented by boxed regions in FIGS. 4C and 4E, respectively.

FIG. 4G is a plot showing that the number of axons in the contralateral gray matter was significantly higher after R00480500-002 treatment compared to that in DMSO-treated controls.

FIG. 5 illustrates a flow diagram of an example process for identifying target and anti-target groupings, in an example.

FIG. 6A illustrates an assurance stratification process performed on compounds stratified by their maximum % NTL prior to matching them with their kinase inhibition data for MR-SVM analysis, in an example.

FIG. 6B illustrates a Maximum Relevance and Support Vector Machines (MR-SVM) analysis applied to identify pharmacologically linked protein (e.g., kinases) groups, in an example.

FIG. 7 is a block diagram of a target/anti-target identification system for implementing the techniques herein, in an example.

FIG. 8 is a flow diagram of a detailed example implementation of a compound subset identification procedure in the process of FIG. 1.

FIG. 9 is a flow diagram of a detailed example of another implementation of a compound subset identification procedure in the process of FIG. 1.

FIG. 10 is a flow diagram of a detailed example implementation of a protein clustering procedure in the process of FIG. 1.

FIG. 11 is a block diagram of a networked-based anti/target matrix generation and new compound prediction system, in an example.

### DETAILED DESCRIPTION

The present techniques provide an approach for deconvolving readily druggable targets directly from a phenotypic screen. The techniques include an automated analysis of various drug targets for treating patients to determine which treatments are more likely to be efficacious over treatments which will not be, or which may be, in fact, before harmful to a patient's condition due to engaging anti-targets. The techniques are able to automatically examine a large number of available drug treatments, for example, and to assess which treatments are target treatments that may be applied to the patient and which ones are not.

In some examples described herein, the techniques have been used to identify compounds with favorable polypharmacology for promoting neurite outgrowth in central nervous system (CNS) neurons, although any number of biological activities can be used to identify compounds for treatment.

The techniques can screen a library of small-molecules or biologicals (e.g., monoclonal antibodies, RNA-based therapeutics, or any other compounds), in a phenotypic assay. Biological activity data for different compounds is collected, stored, and provided to a specifically developed information theory and machine learning trained platform (also termed an identification system) that automatically relates the effects of compounds on an identified biological activity, such as neurite outgrowth, to the effects of compounds on an identified biochemical activity, such as kinase inhibition. As described herein any number biological and biochemical activity indicators may be used.

In some examples described herein, the techniques are used to perform an analysis to identify kinases whose inhibition is likely to promote neurite outgrowth as target kinases and others whose inhibition is likely to repress neurite outgrowth as anti-targets kinases. The result is that the techniques identified a relatively small number of robust targets and anti-targets. Further, the techniques identified compounds with favorable pharmacology, showing that these compounds strongly increased neurite outgrowth in the phenotypic assay.

More broadly, these techniques are able to rank and identify compounds based on their engaged biological activity for targets and anti-targets of any suitable type of protein, e.g., proteins that can be biochemically assayed. Example protein target and anti-targets include enzymes, such as oxidoreductases, transferases, hydrolases, lyases, isomerases, and ligases, as well as ligands, accessory proteins, receptors, and the like that trigger or inhibit enzyme activity. Specific examples of proteins include, but are not limited to, hydroxylases, oxidases, peroxidases, oxygenases, dehydrogenases, kinases, reductases, deaminases, phosphatases, peroxidases, proteases, transferases, G-protein coupled receptors (GPCR), ion channels, importer channels, exporter channels, nuclear receptors, topoisomerases, HDAC, bromodomains, demethylases, Cytochrome P450, carboxylases, aldolases, dehydratases, and the like.

The biologic activity may be a decrease in cell proliferation. In such examples, engaging target proteins may decrease cell proliferation, and engaging anti-target proteins may increase cell proliferation. In some examples, the biologic activity is a decrease in cancer cell proliferation, for example. In some examples, the biologic activity is viability/cytotoxicity/apoptosis, 2D growth (cell mass), 3D growth (spheroid size), migration, invasion, autophagy, cell cycle arrest, or surface marker expression. In some examples, the biologic activity is a decrease in cell proliferation, such that engaging target proteins induces cell death and engaging anti-target proteins prevents cell death. In some examples, the biologic activity may be a decrease in cell proliferation, such that engaging target proteins prevents cell proliferation and engaging anti-target proteins induces proliferation.

As discussed below, in an example, the present techniques were applied to cell viability screening utilizing the ErbB-2 addicted breast cancer cell line SK-BR-3, as well as kinases that were recently described to mediate resistance to therapies that target the ErbB family of tyrosine kinases. We were able to quickly identify the EGFR/ErbB family as among the top identified target candidates. Further still, the present techniques provided unexpected results by identifying kinases believed to be target kinases in a triple negative breast cancer cell line, but that should have been labeled as anti-target kinases. Using the present techniques we were able to identify previously unknown anti-targets in a synovial carcinoma cell line.

In some examples, the techniques were used to identify both targets and anti-targets, using neurite outgrowth as the biologic activity. As a result, the techniques identified a number of kinase proteins (including, for example, rho-associated protein kinases (ROCKs), protein kinase Cs (PKCs), ribosomal s6 kinases (RSKs), cyclin-dependent kinases (CDKs), and mitogen-activated protein kinases (MAPKs)) that had already been described as regulators of neurite outgrowth. But the techniques herein identified other target protein kinases as novel targets, including activated CDC42 kinase, P13-kinase 6, cGMP-dependent protein kinase G1, and cAMP-dependent protein kinase X. These unexpected kinase targets, which were previously presumed anti-targets or non-targets, were identified by our techniques and independently examined using RNAi to confirm the target results.

The present techniques can identify single compounds, as well as groups of compounds, as desirable for treatment, i.e., compounds activating a desired target or groups of targets.

For example, in the neurite growth examination, compound R00480500-002 had a pronounced positive effect on neurite outgrowth. Among its identified targets, R00480500-002 inhibits both PKC and ROCK, two kinases known to mediate repression of axon growth by myelin and CPSGs in the CNS. RO0480500-002 also inhibits the growth regulatory S6 kinases, which have been shown to limit intrinsic neuronal capacity for axon growth and regeneration. Moreover, RO0480500-002 inhibits cGMP-dependent protein kinase G 1 and cAMP-dependent protein kinase X, two kinases involved in the regulation of cell migration and cytoskeletal rearrangement. RO0480500-002 also promoted sprouting of corticospinal axons after pyramidotomy, suggesting that its polypharmacology profile may provide an opportunity for developing effective drugs for neuroregenerative applications.

While achieving favorable polypharmacology in a single drug has advantages, it is also useful in some cases to combine drugs for optimal interactions with multiple targets. Therefore, the present techniques include a deconvolution process. Using this deconvolution process, the present techniques were shown to identify multiple compounds (e.g., two compounds) having complementary polypharmacology, that when combined inhibited all identified targets in one testing (e.g., seven targets). We found that treating cells with a combination of the two compounds promoted neurite outgrowth with higher efficacy (and at a smaller dose) than that with any individual compound or other non-target-guided combination tested.

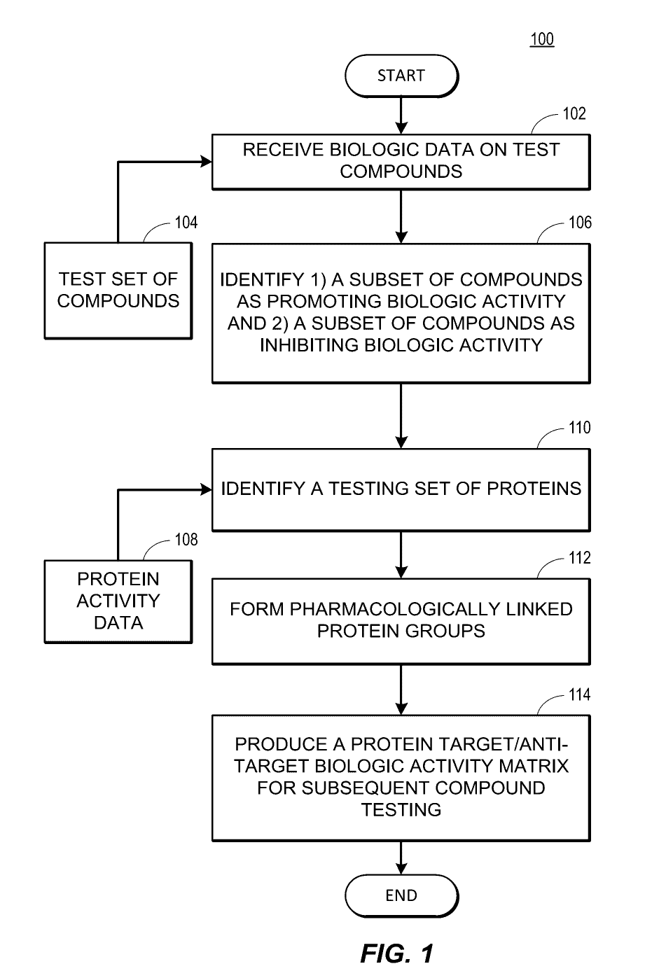

FIG. 1 illustrates an example implementation of a process 100 for developing a target/anti-target activity matrix of compounds and targets/anti-targets, in accordance with the techniques herein.

Initially, at 102, biologic activity data on a series of test compounds is received at the target/anti-target identification system. For example, the biologic activity data is received from an external database 104 of biologic activity data. In other examples, the system may be configured as part of a phenotype testing device that tests and records biologic activity data for compounds.

The identification system may request the biologic data on the test compounds or that data may be pushed to the system. In some examples, the identification system requests only a subset of data, e.g., biologic activity data corresponding to a subset of test compounds, such as those test compounds that correspond to particular population or demographic conditions. A user may input such population or demographic data, and the identification system may automatically assess those data for relevant population and demographic conditions and use those conditions to request biologic activity data on those compounds that have been determined to correspond to those conditions, i.e., compounds that are more likely to be expressive of biologic activity for an identified population or demographic. The biologic activity data may be the format of data table listing a large number of compounds and the neurite outgrowth (% NTL) at different concentrations, for each compound. An example data structure would be as follows.

| Compound Name | NTL_32 | NTL_160 | NTL_800 | NTL_4000 | NTL_20000 |
|---|---|---|---|---|---|
| RO0480500-002 | 115.1472 | 145.776 | 190.2491 | 411.8122 | 267.1213 |
| GSK398099A | 100.7527 | 86.99133 | 91.2121 | 234.4329 | 357.738 |
| SB-682330-A | 231.4174 | 241.7985 | 338.8155 | 38.63001 | 0 |
| GSK1581428A | 229.399 | 335.5001 | 262.488 | 92.83518 | 36.79151 |
| GW693028X | 114.3254 | 101.7908 | 99.07148 | 110.3241 | 296.1224 |
| Flt-3 Inhibitor III | 227.0293 | 250.8023 | 291.5283 | 105.129 | 48.43858 |
| ML-7, Hydrochloride | 193.8632 | 288.4679 | 285.3279 | 269.3169 | 70.23065 |
| MEK1/2 Inhibitor | 109.3381 | 101.2957 | 104.668 | 120.1756 | 286.068 |

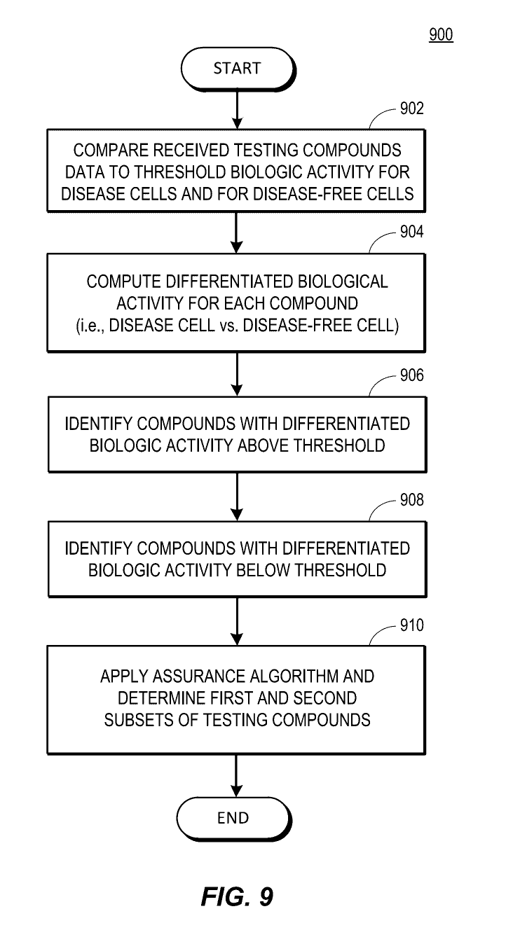

At 106, the system identifies, from the biologic activity data, a first set of compounds promoting biologic activity and a second set of compounds inhibiting biologic activity. FIGS. 8 and 9 illustrate example processes that the system may use in making this identification.

In FIG. 8, for example, the process 106 is implemented through a compound identification process 800 in which, at 802, the received biologic activity data for a set of compounds is compared against a threshold amount of biological activity. Compounds having biologic activity data that exhibits an amount of biological activity above the threshold are identified from this comparison, at a block 804. Compounds having an amount of biologic activity below the threshold are identified by a block 806. With two preliminary compound groups identified, an assurance stratification algorithm is applied to each group, at 808. For the compound group above the threshold, the assurance stratification algorithm is applied to identify as a first subset of compounds, those compounds having a biological activity above the threshold, and with a high level assurance. Similarly, for the compound group below the threshold, the assurance stratification algorithm is applied to identify a second subset of compounds having an amount of biological activity below threshold, and with a high level of assurance.

Assurance stratification can be applied to data sets through a number of different techniques, including, for example, percentage of activity above/below a threshold activity level. Further, the assurance stratification gap can be increased or decreased depending on the availability (or scarcity) of data and the needs of the experiment. In general terms, we can express a removed data stratum as μ ± xσ, where μ is the activity threshold, a is the activity standard deviation, and x is a variable. That is, all compounds with an activity ranging between (μ-xσ) and (μ+xσ) would be removed from the analysis. This bounded range about the μ activity threshold is the removal region, such that compounds with activity levels outside that range are determined to have sufficient assurance for further analysis by the system.

In FIG. 9, the process 106 is implemented through a compound identification process 900 that, like process 800, receives biologic data for a set of compounds, at 902, and compares that received data against a threshold amount of biological activity. A 904, a differential biological activity amount for the compounds is determined. Unlike FIG. 8, in the process 900, the differential biological activity is compared against a threshold amount of differential biological activity for assigning the compounds to preliminary groups. The differential biological activity is determined by for each compound by determining the difference between the biological activity on a disease cell versus the biological activity on a disease-free cell. At 906, the compounds resulting in an amount of differential biological activity above a differential biological activity threshold are identified, and the compounds resulting in a differential biological activity below that threshold are identified at 908. As with the process 800, in the illustrated example, an assurance stratification algorithm is then applied to identify the first subset of compounds and the second subset of compounds, at 910.

At FIG. 1, after the process 106, a series of testing proteins are received by the system, e.g., from protein activity data (108) externally obtained or obtained by the system. A testing set of proteins may be identified from the protein activity data, at 110.

The identification system may identify the testing proteins through any number of automated techniques. In an example, a maximum relevance algorithm process is applied to the protein activity data by. The algorithm quantifies the distribution of biochemical activities of hits and non-hits against a protein. If the distribution is similar in both hits and non-hits (i.e., if the same proportion of hits and non-hits have biochemical activity against the protein), then the relevance of that protein is low. If the biochemical activities are unevenly distributed (e.g., if many more hits than non-hits have biochemical activity against the protein), then the relevance for that protein is high. And vice versa. In this way, the maximum relevance algorithm is able to identify both target and anti-target proteins from this process.

With the maximum relevance algorithm applied, the system then applies a machine learning algorithm to identify a minimum set of a proteins satisfying a prediction threshold value. That minimum set of proteins is identified as the subset of testing proteins for the process 110, where the process 110 determines a biological activity score for each protein in the subset.

Based on the compound data, examination of compound engagement with the testing proteins, in combination with additional protein data (e.g. amino acid sequence of 3-D structure comparisons), target proteins, anti-target proteins, the proteins identified by process 110 are grouped into pharmacologically linked protein groups, at 112. These linked groupings can also be made from these information sources in combination with additional protein data (e.g., amino acid sequence of 3-D structure comparisons).

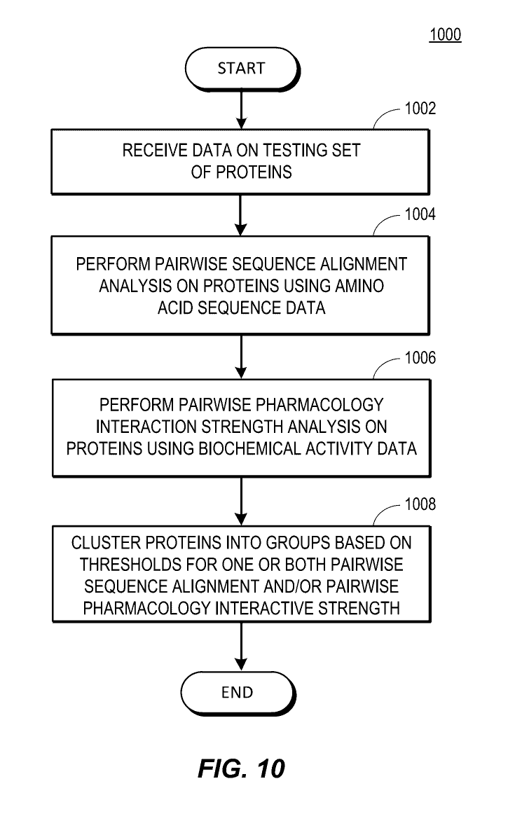

FIG. 10 illustrates an example implementation of the process 112. The testing set of proteins are received at 1002, and, at 1004, a pairwise sequence alignment analysis is performed on the set using amino acid sequence data received from the database 108. The pairwise sequence alignment analysis quantifies the sequence similarity between each pair of proteins. Typically, such an analysis is used as a measure of the evolutionary distance (relatedness) between protein pairs. The more similar the sequences are, the shorter the evolutionary distance is between the two proteins (i.e., the more related they are). In the present techniques, however, the system uses the sequence similarity as a proxy measure for biochemical similarity, i.e., the likelihood that the proteins would bind the same molecules with similar potency.

At 1006, a pairwise pharmacology interaction strength analysis is performed on a set of proteins using biochemical activity data. In some examples, the amino acid sequence data is acquired from publically available repositories (e.g., NCBI), and the biochemical activity data is obtained from testing the compounds in biochemical assays with the proteins.

In any event, the proteins are clustered into groups, at 1008, based on a comparison of the pairwise sequence alignment data to a threshold. Or, proteins may be clustered based on a comparison of the pairwise pharmacology interaction strength data to a threshold. Or, in yet other examples, both the pairwise sequence alignment data and the pairwise pharmacology interaction strength may be compared to separate thresholds, and the combination may be used to cluster proteins into groups.

At FIG. 1, at 114, the system produces a protein target/anti-target matrix based on the received compound and target/anti-target protein data. That matrix that may be used for further compound testing, e.g., to assess activities of compounds on matrix proteins for determining treatments of various pathologies related to protein function.

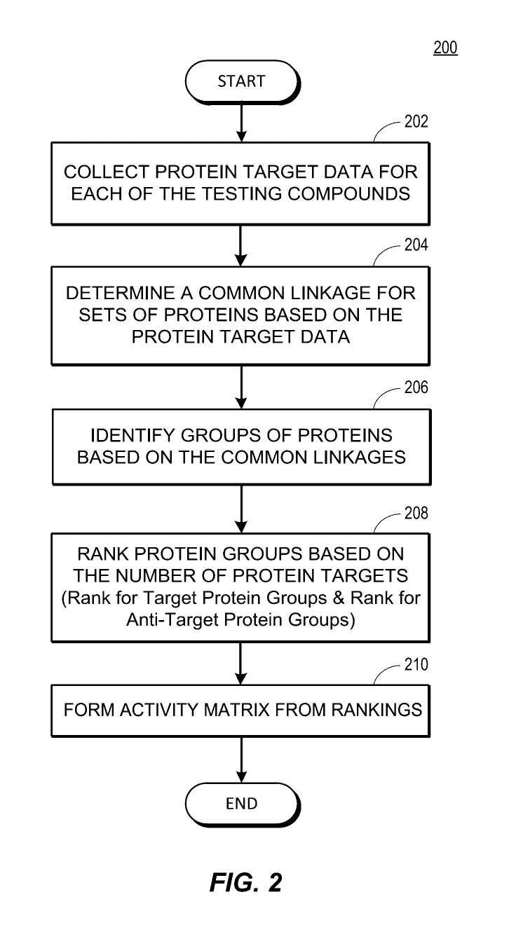

FIG. 2 illustrates an example, more detailed process 200 for producing the target/anti-target matrix, in accordance with an example. At 202, the system collects protein target data for each of the testing compounds, from which the system determines, at 204, a common linkage for sets of proteins based on this target data. At 206, the system identifies groups of proteins based on the common linkages. At 208, the system ranks the protein groups, i.e., ranking both target groups and anti-target groups based on a characteristic, such as the number of protein targets contained within the respective groups. From there, the target/anti-target matrix is determined, formed, and stored or displayed, at 210.

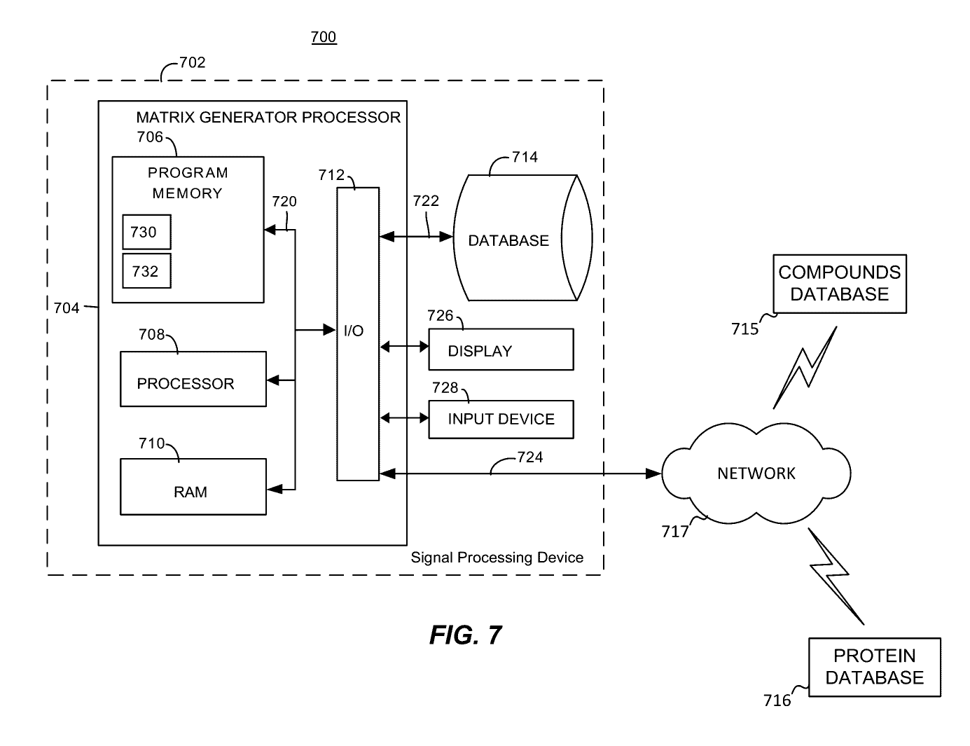

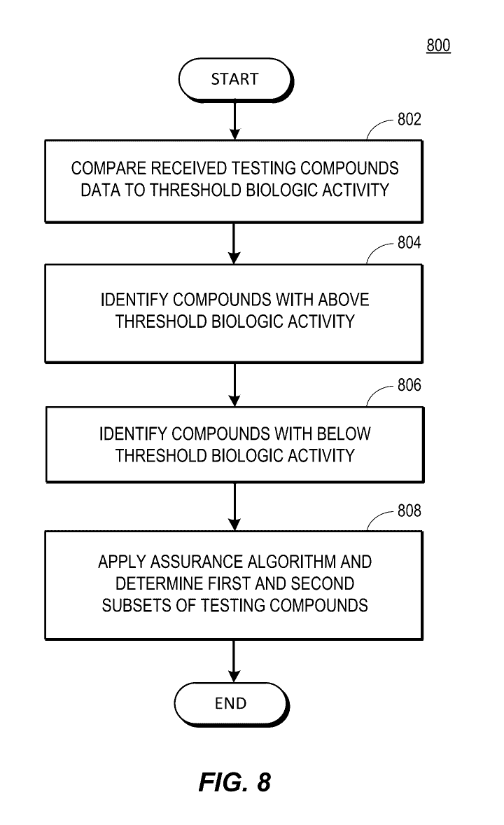

FIG. 7, described below, illustrates an example identification system for implementing the techniques herein.

### EXAMPLE

### Neurite Outgrowth Examination

We now describe an example implementation of the present techniques.

Materials. Mouse α-βIII tubulin antibody was prepared in house. Rabbit anti-βIII, an Alexa Fluor 488 cross-linked goat anti-mouse, and anti-rabbit antibodies were purchased.

Kinase Inhibitor Libraries. A collection of kinase inhibitor libraries were used, including: EMD Millipore's InhibitorSelect™ Protein Kinase Inhibitor libraries I, II, & III (approximately 240 compounds), a hit-focused library (150 compounds) was designed by querying Vichem's Extended Kinase Inhibitor database for compounds with structural similarity (Tanimoto>0.7, using FP fingerprint) to hits previously identified within the EMD libraries, a library of clinically tested kinase inhibitors (approximately 130 compounds) assembled from commercial vendors, GlaxoSmithKline's Published Kinase Inhibitor Set I and II (PKIS-I and PKIS-II) libraries (approximately 900 compounds), and Roche's Published Kinase Inhibitor Set (235 compounds).

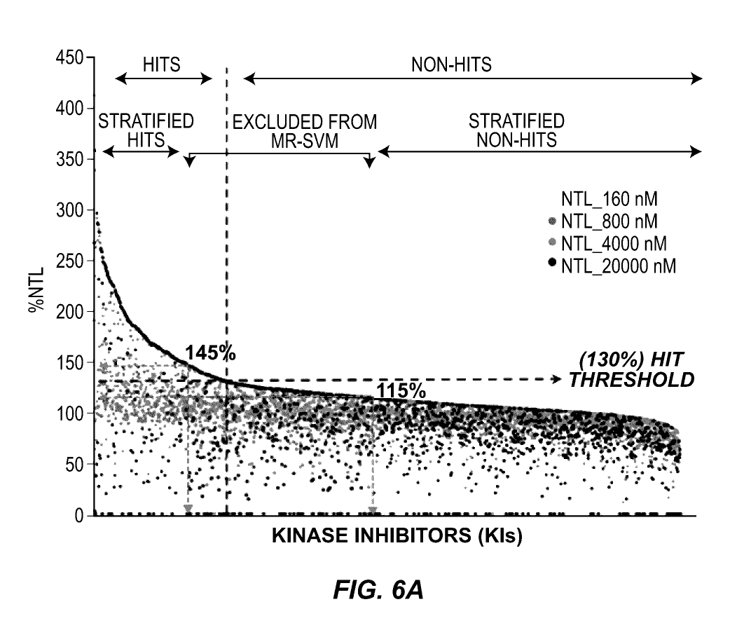

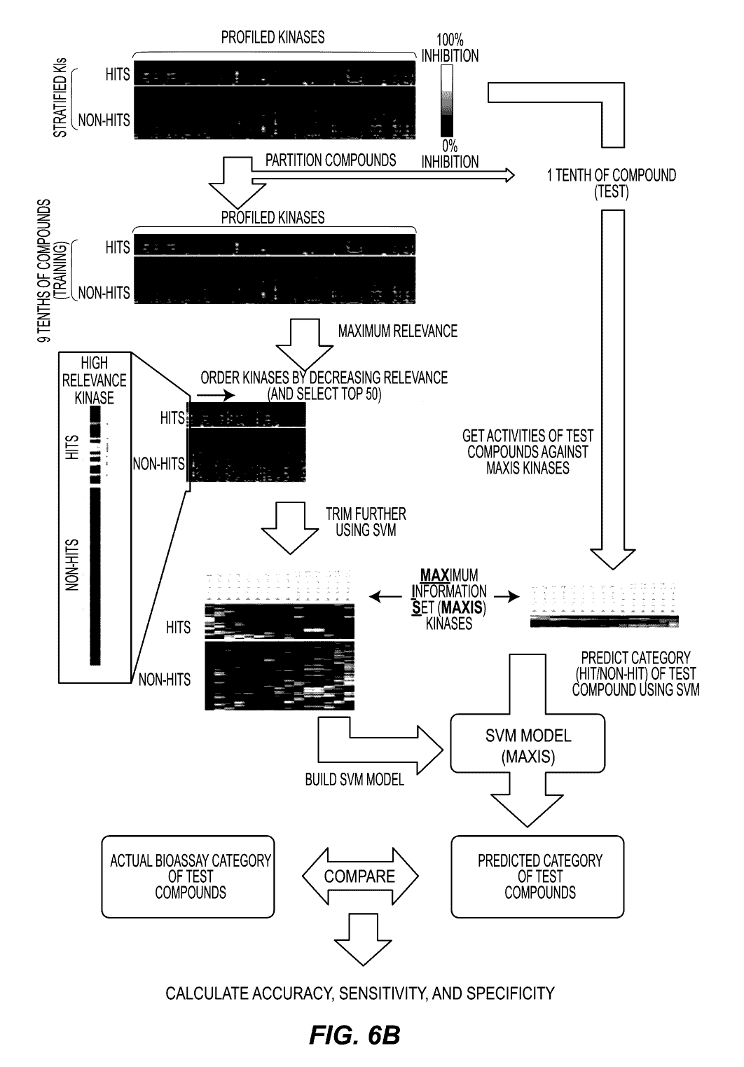

Neurite Outgrowth Screening Assay with Hippocampal Neurons. Kinase inhibitor libraries were screened in a neurite outgrowth assay. Compounds were screened on rat embryonic (E18) hippocampal neurons cultured for 2 DIV on poly-D-lysine. Plates were fixed, immunostained, and imaged. Screened compounds were classified based on their effects on neurite total length, expressed as percentage of control (% NTL), which served as the biological activity referenced in FIG. 1, for this example. Hits were defined as compounds whose biologic activity (% NTL) reached at least 130% in two independent experiments (hits: % NTL 130; non-hits: % NTL<130). That is, in this example an NTL of 130 was used as the threshold measure (see, e.g., FIGS. 8 and 9). Non-hits were defined as compounds whose % NTL did not cross the 130% threshold in either experiment. A stratification (assurance) step was performed by eliminating from subsequent analysis compounds that had biologic activity within 1 standard deviation of the hit threshold (130±15) (see, e.g., FIG. 6A). Compounds that reduced viable cell count (biologic activity) by more than 40% at concentrations below 800 nM were considered to be toxic and also excluded from subsequent analysis.

Cell Viability Screening Assay. The PKIS-I library compounds were screened against the SK-BR-3 breast cancer cell line at five concentrations covering a 10000-fold concentration range (1-10000 nM) in the same way as previously described for drug sensitivity and resistance testing (DSRT) for primary leukemic cells. Viability in the test wells was normalized to the numbers from vehicle (0.1% DMSO) and cell killing treated (100 μM benzethonium chloride) wells. The five concentration data points for each compound were fitted to a dose—response curve, and a drug sensitivity score (DSS) was calculated. A differential DSS (dDSS) representing an SK-BR-3-selective response for each compound was subsequently established by subtracting the average compound DSS from 25 cell lines (19 breast cancer and 6 pancreatic adenocarcino-mas) from the SK-BR-3 compound DSS.

Activity Profiling of Screened Kinase Inhibitors. In vitro profiling of kinase inhibitors against a panel of 190 kinases was performed. Out of bound values were cropped, whereby values below 0% were adjusted to 0%, and values above 100% were adjusted to 100%.

Identifying Groups of Pharmacologically Linked Kinases. Kinases that are likely to be inhibited by the same compounds may represent one another in the Maximum Relevance and Support Vector Machines (MR-SVM) analysis performed by the present techniques (e.g., at 110).

Pharmacological linkage (e.g., at 112) can be determined in numerous ways. In this example, amino acid sequences of a set of kinase domains were obtained and compared pairwise for sequence similarity using the Needleman—Wunsch global sequence alignment algorithm. Kinases were also compared pairwise for pharmacological similarity using a modified version of the pharmacological interaction strength (Pᵢⱼ) term:

$${P}_{ij} = \frac{{N}_{ij}^{coactive}}{{N}_{ij}^{active}}$$

where Nᵢⱼ^{active} is the number of compounds that showed >10% inhibition against either kinase i or j (or both) and Nᵢⱼ^{coactive} is the number of compounds that had above-threshold inhibition against both kinases. Kinases were grouped together so that any two kinases with a Pᵢⱼ score>0.6 (direct measure) or a sequence similarity score>0.7 (indirect measure) belonged to the same group.

The computer-implemented identification system, having at least one processor and at least one memory storing computer-readable instructions, was used to apply a support Vector Machine (SVM) process. The SVM was trained using a linear kernel with a boxconstraint=1 and no data scaling. In this example, testing compounds were identified as follows: a compound must have >10% inhibition activity against at least one of the kinases in a data set for it to be included in SVM training or testing (compounds with no activity against all kinases were ignored). In 10-fold cross-validation SVM experiments, compounds were first divided into 10 parts while keeping the hits/non-hits ratio constant. The SVM was trained with nine parts (training examples) and then tested with the remaining tenth part (test examples). The process was repeated until all parts had been used as test examples, for a total of 10 tests. Finally, SVM predictions were compared to bioassay results to calculate accuracy (correctly predicted compounds/total compounds x 100), sensitivity (correctly predicted hits/total hits ×100), and specificity (correctly predicted non-hits/total non-hits ×100).

In another aspect of this example implementation, the system included (selecting, identifying, and/or prioritizing) a Maximum Information Set (MAXIS) of Kinases Using Maximum Relevance and Support Vector Machines (MR-SVM) that is used identify the subset of protein kinases to be engaged for in order to produce a sufficient amount of biologic activity. In an example that biologic activity was neurite outgrowth.

Any number of machine learning algorithm-based processes may be used, of which support vector machine algorithms are an example. Other example machine learning algorithms include decision tree algorithm, association rule, artificial neural network, deep learning algorithm, inductive logic algorithm, clustering algorithm, Bayesian network, reinforcement learning algorithm, representation learning algorithm, similarity and metric learning algorithm, sparse dictionary learning algorithm, genetic algorithm, rule-based machine learning, or learning classifier systems algorithm. Further, the machine learning algorithm may be supervised or unsupervised.

The system applied assurance stratification to the data set (see, e.g., FIGS. 8 and 9) to produce a data set with a higher level of assurance for targets and anti-targets. For example, the system excluded from analysis compounds whose maximum % NTL fell within ±15% of the hit threshold of 130%. The assurance stratification accentuates differences between the hit and non-hit categories and improves selection of relevant targets and anti-targets. The remaining compounds that were profiled in a kinase activity panel comprised the input for the analysis. A total of 256 compounds (72 hits and 184 non-hits) with profiling data against 190 kinases constituted the input to the MR-SVM analysis engine within the activity matrix system.

To identify a set of potential targets/anti-targets, a maximum relevance (MR) algorithm was used to calculate a relevance score (as quantified by mutual information I) for each profiled kinase according to the following formula:

$$I ( h , k ) = {\sum }_{i , j} p ( hi , kj ) log \frac{p ( hi , kj )}{p ( hi ) p ( kj )}$$

where I(h,k) is the mutual information between kinase k inhibition and compound category h, h={hit,non-hit}, p(h) and p(k) are the respective marginal probabilities, and p(h,k) is the joint probability distribution. The 50 top-scoring kinases were trimmed using a support vector machine (SVM) learning algorithm. Inhibition profiles were discretized to convert the continuous (0-100%) inhibition range to a discrete integer range (0-10%=1, 10-20%=2 , . . . , 90-100%=10). The SVM was trained to classify compounds as hits or non-hits based on their inhibition profiles against the 50 most relevant kinases. SVM performance with the relevant kinases was assessed using 10-fold cross-validation. Then, kinases were iteratively removed from the model (by deleting inhibition activity points corresponding to the kinase). If removing a kinase degraded the SVM performance, then the kinase was added back into the model. Otherwise, the kinase was discarded. A differential prediction metric, Cperf, was developed and used to track SVM performance and maintain sensitivity as kinases are removed. Cperf evaluates the scalar difference between sensitivity and error:

$$Cperf = ( \frac{TP}{TP + FN} ) - ( \frac{PF + FN}{FP + FN + TP + TN} )$$

where TP is the number of true positives, FP is the number of false positives, TN is the number of true negatives, and FN is the number of false negatives. SVM performance was considered to be degraded if removing a kinase decreased Cperf by an amount greater than a preset buffer_value. The training data set was parsed several times, starting with a buffer_value of 1% and then halving this value after every round. If, at any point, a compound had inhibition activity <10% against all kinases within a set, then it was automatically excluded from the analysis. Similarly, if at any point a kinase had no compounds that inhibit it >10%, then it was automatically dropped. This process was continued until one of two conditions was met: (1) no kinases could be removed without degrading the SVM performance or (2) the number of kinases reached a preset minimum value (set to 15). The resultant set of kinases comprised the maximum information set (MAXIS). The MAXIS score of each pharmacologically linked group of kinases was calculated by adding up the number of times (out of 100 total runs) the group appeared in the MAXIS by at least one of its members.

Calculating Kinase Inhibition Bias. Inhibition bias B for every kinase k (Bₖ) was calculated using a kinase profiling data according to the following equations

$${B}_{k ( f )} = \frac{{F}_{hits}^{active}}{{F}_{hits}^{active} + {F}_{non \text{-} hits}^{active}} - \frac{{F}_{non \text{-} hits}^{active}}{{F}_{hits}^{active} + {F}_{non \text{-} hits}^{active}}$$

$${B}_{k ( l )} = \frac{{MEAN ( A )}_{hits}^{active} - {MEAN ( A )}_{non \text{-} hits}^{active}}{100} - \\ {B}_{k} = {B}_{k ( f )} + {B}_{k ( l )}$$

where B_{k(f)} ∈ [−1,1] is inhibition frequency bias (calculated as the difference of normalized frequencies), Bₖ₍ₗ₎ ∈ [−1,1] is inhibition intensity bias, Fₕᵢₜₛ^{active} is the frequency of compounds in the hits category that inhibit k by 10%, Fₙₒₙ₋ₕᵢₜₛ^{active} is the frequency of compounds in the non-hits category that inhibit k by≧10%, MEAN(A)ₕᵢₜₛ^{active} is the mean inhibition activity of all hits that inhibit k 10%, and MEAN(A)ₙₒₙ₋ₕᵢₜₛ^{active} is the mean inhibition activity of all non-hits that inhibit k≧10%. A positive value indicates inhibition bias by hits, whereas a negative value indicates inhibition bias by non-hits. The average inhibition bias for pharmacologically linked group of kinases was calculated by averaging all Bₖ values calculated for members within a group.

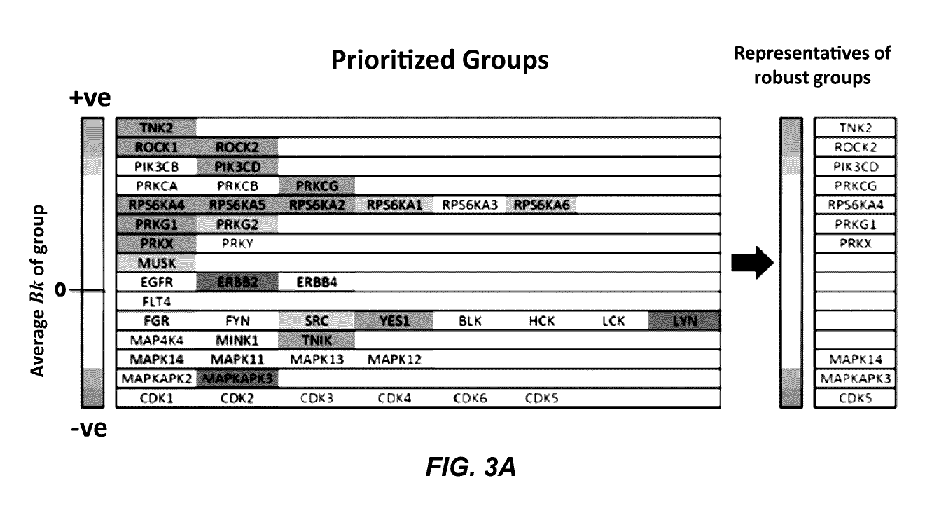

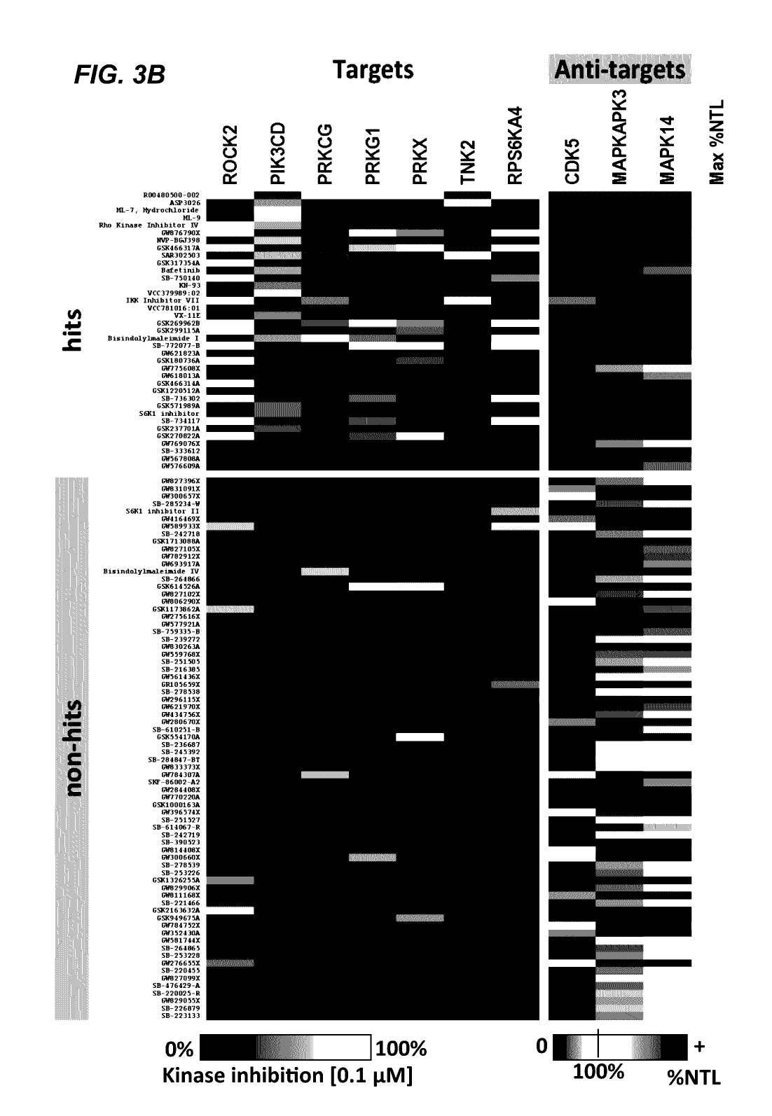

FIGS. 3A-6B illustrate results of this example implementation of the techniques herein.

FIG. 3A illustrates prioritized groups of kinases representing robust target and anti-target grouping for accurate prediction of compound biologic activity as determined by the present techniques. Specifically, the groups were selected through the MR-SVM engine executing on the system, with a combined score, composed of group MAXIS score multiplied by the group average Bₖ, used to rank the groups based on biologic activity, such as neurite outgrowth parameters, and select the top 15 scoring groups. The groups are ordered from top to bottom by decreasing group average inhibition bias (average Bₖ), representing positive average Bₖ at the top (strong target groups) and negative average Bₖ at the bottom (strong anti-target groups).

Single representative kinases (right hand side of graphic) were selected from robust target and anti-target groups.

FIG. 3B illustrates a resultant target-anti-target activity matrix developed by the identification system (e.g., at process 114). The target/anti-target matrix identifies protein target groups separately from protein anti-target groups, where each group type may be ranked according to various factors, such as biologic activity and inhibition bias. Engagement of the protein targets in the matrix promotes a biological activity; and engagement of the protein anti-targets in the matrix impedes the biological activity. In the particular example of FIG. 3B, representative protein kinases for each kinase group and the compounds that inhibit at least one member in the group by ≧10% are shown. Activity distribution shows a strong correlation between target inhibition and hits (biased inhibition of targets by hits) and between anti-target inhibition and non-hits (biased inhibition of anti-targets by non-hits). Compounds are arranged top to bottom in order of decreasing maximum % NTL (right-hand color scale). RO0480500-002 (the top arrowhead), strongly inhibits more representative target kinases (total of five) than any other compound and does not inhibit any representative anti-target kinases. RO0480500-002 accordingly produced % NTL up to 400%, well above the % NTL of any of the other compound. The matrix further illustrates that ASP3026 inhibits the two target kinases not inhibited by R00480500-002 and, like R00480500-002, does not inhibit any representative anti-target kinases. Therefore, an identification system that determines compounds for treatment may, as described herein, identify a combined compound grouping of both ASP3026 and RO0480500-002 for treatment, if further maximization of target kinase inhibition is desired.

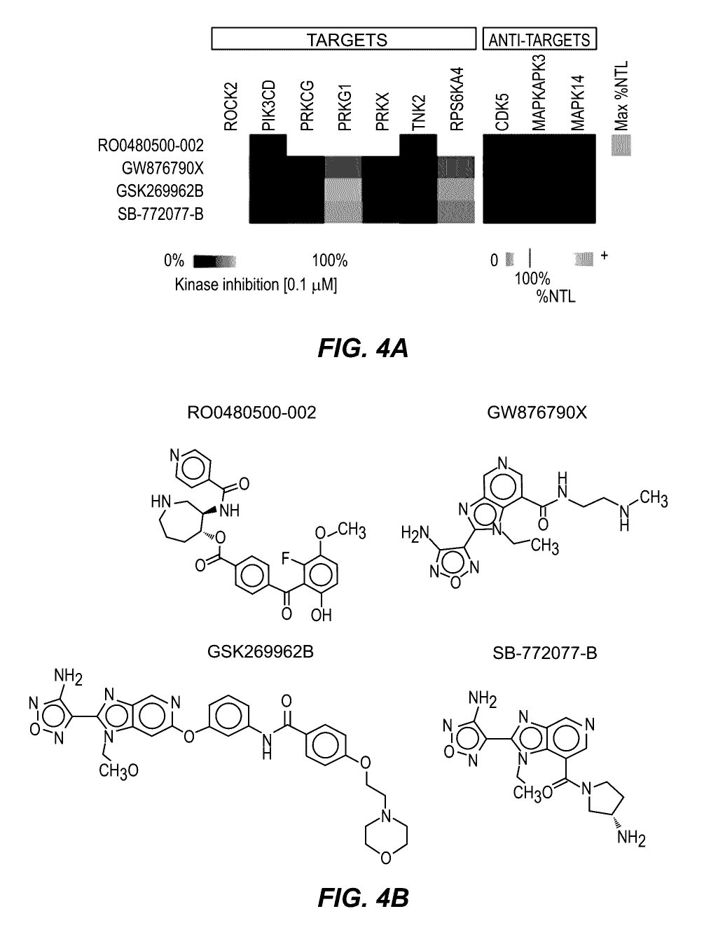

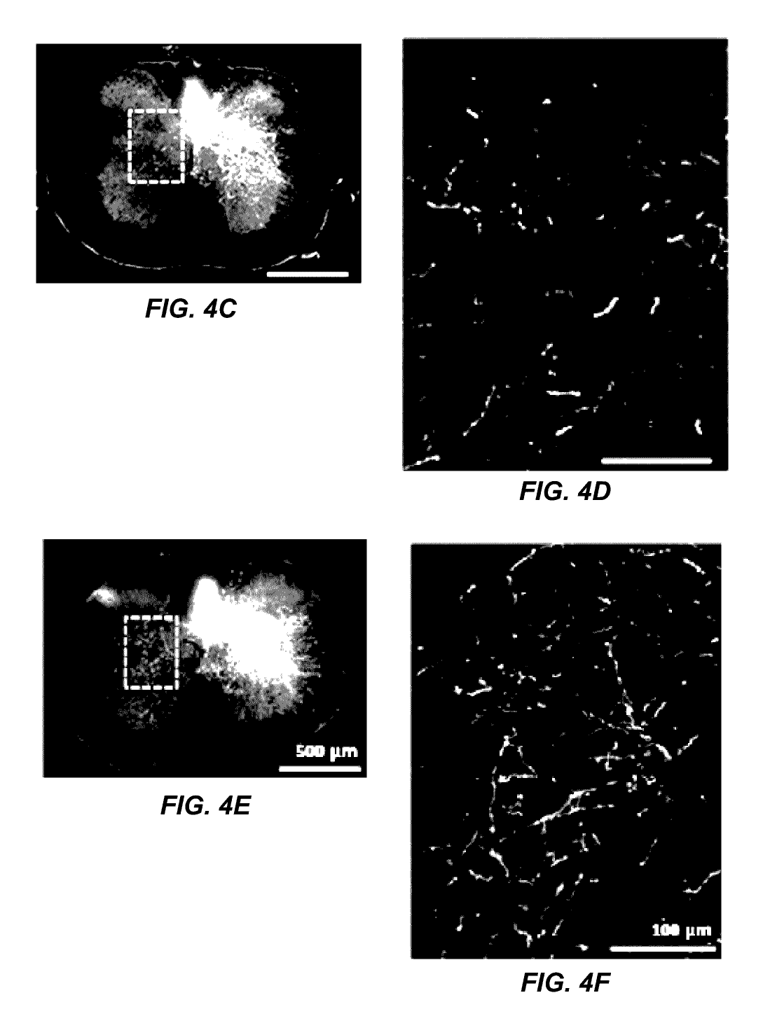

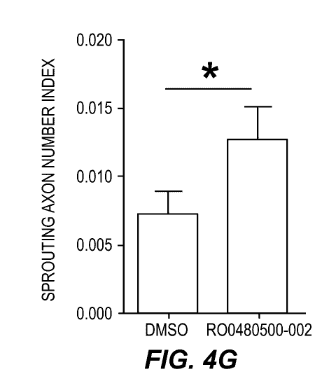

FIGS. 4A-4G shows that favorable polypharmacology (inhibition of multiple targets and no anti-targets) of kinase inhibitions strongly correlated with improved neurite outgrowth in vitro and axon growth in vivo. FIG. 4A illustrates examples of hits with favorable polypharmacology and very strong effects on neurite outgrowth promotion. FIG. 4B illustrates that RO0480500-002 has no chemical similarity (Tanimoto<0.5, FP fingerprint) to three other hits with analogous polypharmacology, suggesting that similar polypharmacology can be obtained with different molecular scaffolds. FIGS. 4C-4G illustrate delivery of RO0480500-002 after pyramidotomy in mice promotes growth of uninjured corticospinal axons into the denervated contralateral gray matter. FIGS. 4D and 4F are magnified images represented by boxed regions in FIGS. 4C and 4E, respectively. FIG. 4G is a plot showing that the number of axons in the contralateral gray matter was significantly higher after RO0480500-002 treatment compared to that in DMSO-treated controls; one-tailed Student's t test; *, p <0.05. Mean ±SEM; n =9 per group.

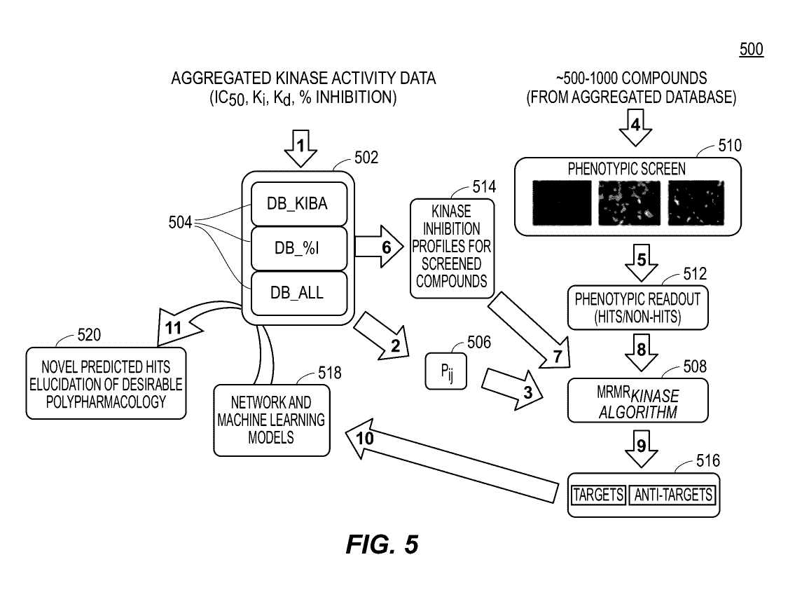

FIG. 5 illustrates a flow diagram of an example process 500 for identifying target and anti-target groupings (with an example ordering of steps listed by numbered arrows). Specifically, FIG. 5 illustrates a summary of target/anti-target deconvolution and polypharmacology hit discovery process according to an example. At 502 (via step 1), kinase activity data from a variety of sources is collected by an analysis identification computer system. The computer system standardizes and aggregates the data into an integrated database 504, as shown. That aggregated data is collectively used to compute pharmacological linkage strengths, 506, for all pairs of kinases. The pharmacological linkage strength values are incorporated into a target/anti-target deconvolution algorithm, MRMRₖᵢₙ 508.

Next (via step 4), compound data is collected by the system, e.g., data for approximately 500 to 1000 compounds selected for this application. At 510, a subset of compounds is screened in a phenotypic assay. At 512, readout data is used to classify compounds as hits or non-hits.

At 514, kinase activity data for screened compounds is fetched from the database 504 thereby identifying kinase inhibition profiles for screened compounds. That data is submitted along with the phenotypic data from 512 to the target deconvolution algorithm 508 in order to predict targets/anti-targets, which are provided at 516. At 518, the targets/anti-targets (validated) are used to construct the computational model that is the activity matrix, using network and machine learning models. At 520, the matrix is assessed to identify new compound hits, particularly those with desirable polypharmacology, whereafter further compounds are tested.

FIG. 6A illustrates an assurance stratification that was performed on compounds stratified by their maximum % NTL prior to matching them with their kinase inhibition data for MR-SVM analysis. FIG. 6B illustrates a flowchart of steps in the MR-SVM algorithm.

As discussed in reference in FIGS. 8 and 9, in some examples, compounds are identified by comparing biologic data received on a set of testing compounds against a threshold amount of threshold amount of biological activity in disease cells and disease-free cells. In such examples, the differential biological activity of compounds on diseased cells and disease-free cells is calculated, from which the techniques automatically identify compounds resulting in an amount of differential biological activity above a threshold and other compounds resulting in an amount of differential biological activity below a threshold. From there, an assurance stratification algorithm may be applied to identify a first subset of compounds as a higher assurance set of compounds having the amount of differential biological activity above the threshold and a second subset of compounds as a higher assurance set of compounds having the amount of differential biological activity below the threshold. The amount of differential biological activity of a compound may be determined as a function of the area under a dose response curve and the maximal effect size in the cell-based assay.

For example, a drug sensitivity scoring (DSS) function, such as that originally developed by, Yadav, et al. “Quantitative scoring of differential drug sensitivity for individually optimized anticancer therapies.” Scientific reports 4 (2014), was implemented with several modifications. Briefly, dose response data for each compound in the cell viability screen were fitted to a three-parameter nonlinear regression according to the formula:

$$y = \frac{Top}{1 + {10}^{( Log EC 50 - x )} * Hillslope}$$

where y is % cell death at concentration x, Top is the maximal effect of the drug (allowed to float between 0% and 100%), EC50 is the concentration at half maximal effect, and HillSlope is the slope of the curve. The relevant area under the curve (rAUC) was calculated by integrating the dose response curve starting at the threshold concentration where the response crosses 10% (xₜ) according to:

$$rAUC = {\int }_{Xt}^{xmax} y ( x ) d x$$

where xₘₐₓ is the maximal concentration in the screen. The drug response area (DRA) was calculated according to the formula DRA=rAUC−tArea, where tArea is the portion of rAUC that lies below the 10% threshold. The modified drug sensitivity score (DSS_{mod}) was calculated according to the formula:

$${DSS}_{mod} = 100 \times \frac{DRA}{MRA} \times {log}_{10} ( \frac{Top}{10} )$$

where MRA is the maximum possible drug response calculated as MRA=(max effect—threshold effect)(xₘₐₓ−Xₘᵢₙ), and xₘᵢₙ is the lowest screening concentration. The

$$log ( \frac{Top}{10} )$$

term serves as a scaling function that penalizes the scores of compounds which fail to reach an effect of 100% cell death over the tested dose range. Finally, the selective DSS_{mod} (sDSS_{mod}) for each drug in each patient screen was calculated according to the formula sDSS_{mod}=DSS_{mod} (patient cells)−DSS_{mod} (normal bone marrow mononuclear cells). As such, the sDSS_{mod} incorporates information on each drug's potency, efficacy, effect range, and therapeutic index, making it possible to prioritize compounds over multiple dimensions of clinically relevant measures using a single numerical metric.

FIG. 7 illustrates an example block diagram 700 that illustrates various components used in implementing an example embodiment of the present techniques. A signal-processing device 702 (or “signal processor” or “diagnostic device”), also termed herein a target/anti-target identification system, is configured to collect protein data and compound data from databases 716 and 715, respectively, connected to the single processing device through a wireless (or wired) network 717. The signal-processing device 702 may have a target/anti-target matrix generator 704 operatively connected to an internal database 714 (that may alternatively house protein and/or compound data) via a link 722 connected to an input/output (I/O) circuit 712. It should be noted that, while not shown, additional databases may be linked to the matrix generator 704 in a known manner. The matrix generator processor 704 includes a program memory 706, one or more processors 708 (may be called microcontrollers or a microprocessors), a random-access memory (RAM) 710, and the input/output (I/O) circuit 712, all of which are interconnected via an address/data bus 720. It should be appreciated that although only one processor 708 is shown, the matrix generator 704 may include multiple microprocessors 708. Similarly, the memory of the matrix generator 704 may include multiple RAMs 710 and multiple program memories 706. Although the I/O circuit 712 is shown as a single block, it should be appreciated that the I/O circuit 712 may include a number of different types of I/O circuits. The RAM(s) 710 and the program memories 706 may be implemented as semiconductor memories, magnetically readable memories, and/or optically readable memories, for example. A link 724, which may include one or more wired and/or wireless (Bluetooth, WLAN, etc.) connections, may operatively connect the matrix generator 704 to the databases 715 and 716 through the I/O circuit 712. In other examples, the databases 715 and 716 may be part of the signal-processing device 702.

The program memory 706 and/or the RAM 710 may store various applications (i.e., machine readable instructions) for execution by the processor 708. For example, an operating system 730 may generally control the operation of the signal-processing device 702 and provide a user interface to the signal-processing device 702 to implement data processing operations. The program memory 706 and/or the RAM 710 may also store a variety of subroutines 732 for accessing specific functions of the signal-processing device 702. By way of example, and without limitation, the subroutines 732 may include, among other things: a subroutine receive biologic data on a set of testing compounds; a subroutine to identify within a set of testing compounds, (i) a first subset of compounds that form an active compound class characterized by producing a desired biologic activity, and (ii) a second subset of compounds that form an inactive compound class characterized by producing no biologic activity or inhibiting the desired biologic activity; a subroutine to receive protein biochemical activity data on the set of testing compounds; a subroutine to identify a subset of proteins from a set of proteins, wherein the subset of proteins comprises proteins that correlate to the first set of compounds and/or the second subset of compounds; a subroutine to cluster the subset of proteins to form pharmacologically linked protein groups; a subroutine to rank the pharmacologically linked protein groups based on an aggregated biological activity score; and a subroutine to produce, from the ranked pharmacologically linked protein groups, a protein target/anti-target biologic activity model (matrix), where the protein target/anti-target biologic activity model (matrix) identifies protein target groups separately from protein anti-target groups, and where engagement of the protein targets promotes a biological activity and engagement of the protein anti-targets impedes the biological activity.

The subroutines 732 may also include other subroutines, for example, implementing software keyboard functionality, interfacing with other hardware in the signal processing device 702, etc. The program memory 706 and/or the RAM 710 may further store data related to the configuration and/or operation of the signal-processing device 702, and/or related to the operation of the one or more subroutines 732. For example, the data may be data gathered from the databases 715 and 716, data determined and/or calculated by the processor 708, etc. In addition to the matrix generator 704, the signal-processing device 702 may include other hardware resources. The signal-processing device 702 may also include various types of input/output hardware such as a visual display 726 and input device(s) 728 (e.g., keypad, keyboard, etc.). In an embodiment, the display 726 is touch-sensitive, and may cooperate with a software keyboard routine as one of the software routines 732 to accept user input.

It may be advantageous for the signal-processing device 702 to communicate with a medical treatment device, medical data records storage device, through the network 717 or through any of a number of known networking devices and techniques (e.g., through a commuter network such as a hospital or clinic intranet, the Internet, etc.). For example, the signal-processing device may be connected to a medical records database, hospital management processing system, healthcare professional terminals (e.g., doctor stations, nurse stations), high throughput screening framework, or other system.

The system 700 may be implemented as computer-readable instructions stored on a single dedicated machine, for example, one with one or more computer processing units. In some examples, the dedicated machine performs only the functions described in the processes of FIGS. 1, 2, 5, and 6B, and any other functions needed to perform those processes. The dedicated machine may be a standalone machine or embedded within another computing machine. In other examples, the functions described in FIG. 2 are integrated within an existing computing machine, such as the machine 700.

In some examples, one or more of the functions of the system 700 may be performed remotely, including, for example, on a server connected to a remote computing device, through a wired or wireless interface at 712 and the network 717. Such distributed processing may include having all or a portion of the processing of system 700 performed on a remote server. In some embodiments, the techniques herein may be implemented as software-as-a-service (SaaS) with the computer-readable instructions to perform the method steps being stored on one or more of the computer processing devices and communicating with one or more user devices, including but not limited to personal computers, handheld devices, etc.

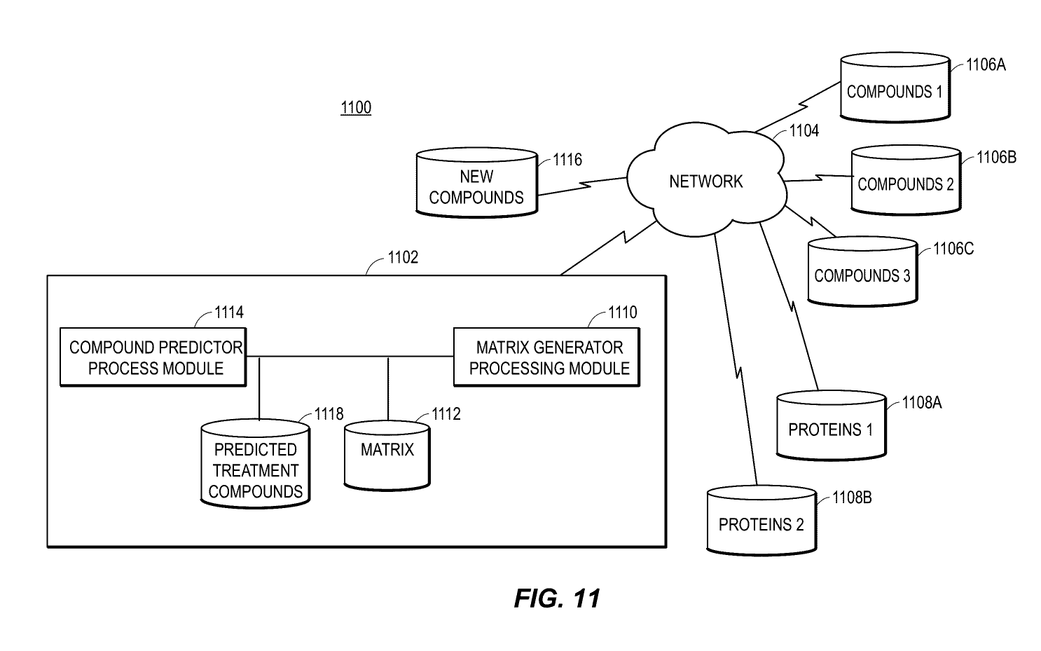

FIG. 11 illustrates an example target/anti-target identification infrastructure 1100 having a target/anti-target identification system 1102, similar to the system 102. The system 1102, which may also be implemented at a server location, is communicatively coupled to a communication network 1104 that is also communicatively coupled to a plurality of computerized compounds databases 1106A, 1106B, and 1106C and a plurality of computerized proteins databases 1108A and 1108B. The compounds databases 1106A-1106C represent databases of different tested compounds from different third parties. For example compound database 1106A may represent a database of compounds tested by one drug manufacturer, while database 1106B represents a database of compounds tested by another drug manufacturer. These databases would typically include tests for 100s to 1000s of different compounds. Prior to the present techniques, biological activity data for such compounds would merely sit within the testing facilities of different manufactures, where the data is laboriously assessed manually by technicians.

The system 1102 poles the databases 1106A-1106C, 1108A, and 1108B and collects the stored data therein. The poling may be periodic. The poling may be initiated by the system 1102, e.g., by sending a poling command over the network 1104. In some examples, the system 1102 may obtain the stored data in response to the databases sending an update command over the network 1104 to the system 1102, the update command identifying when the respective database has been updated, for example, with new compounds and/or new biologic activity data.

The system 1102 includes a target/anti-target identification matrix generator processing module 1110, similar to the process 104 of FIG. 7. The processing module 1110 collects the compounds data from the different databases 1106A-1106C and develops a combined target/anti-target matrix. Advantageously, this combined target/anti-target matrix would include the generation of first sets of compounds and second sets of compounds, which the sets include compounds across the different databases. For example, a desired level of biological activity may be set at the system 1102, and the system 1102 then collects compounds data from the different, isolated databases, and identifies the compounds (or compound groupings) based on whether they (i) produce a desired biologic activity, (ii) produce no biologic activity, and/or (iii) they inhibit a desired biologic activity. The results are heretofore-new combinational compounds groupings.

Further still, the processing module 1110 identifies proteins across the proteins databases that correlate to the compounds and/or compound groupings. The identified subsets are then pharmacologically linked and ranked producing, with the compound data, a combined target/anti-target matrix 1112 populated with compound and protein data across the databases.

The system 1102 also includes a compound testing predictor processing module 1114 coupled to the target/anti-target matrix 1112 and communicating with a second set of testing compounds 1116 through the network 1104. The second set of testing compounds may represent a new set of compounds that a third party wishes to test against previously applied testing compounds of the matrix 1112. These second set of testing compounds, for example, may represent potential new drug treatment compounds that the system 1102 will assess in comparison to a previously stored matrix to identify which of these new compounds are likely to engage one or more pharmacologically linked protein groups, based on the biologic activity data of a similar compounds stored in the matrix.

The compound testing predictor processing module 1114 in some examples will identify the compound or compounds, in the new compounds database 1116, that express the largest number of target protein groups, the smallest number of anti-target protein groups, or some desired combination of expressed target protein groups and non-expressed anti-target protein groups.

The compounds from the database 1116 identified by the processing module 1114 represent a candidate subset of compounds for treating a particular pathology. These predicted testing compounds are stored in a second database 1118 that may be accessed by a third party testing facility (not shown). The database 1116 may store the compounds in groups, where at least some of the compound groups are able to engage one or more targets. The more targets engaged by a compound grouping (or compound) the better, whereas the more anti-targets engaged by a compound grouping (or compound) the worse. Therefore, the database 1116 identifies the compounds and compounds groupings that engage all or the most targets and none or the fewest the anti-targets.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. A computer-implemented method of classifying potential treatment compounds based on a model of biologic activity, the method comprising:
receiving, at one or more processing units, biologic data on a set of testing compounds;
identifying, at the one or more processing units, within the set of testing compounds, (i) a first subset of compounds that form an active compound class characterized by producing a desired biologic activity, and (ii) a second subset of compounds that form an inactive compound class characterized by producing no biologic activity or inhibiting the desired biologic activity;
receiving, at the one or more processing units, protein biochemical activity data on the set of testing compounds;
identifying, at the one or more processing units, a subset of proteins from a set of proteins, wherein the subset of proteins comprises proteins that correlate to the first set of compounds and/or the second subset of compounds;
clustering, at the one or more processing units, the subset of proteins to form pharmacologically linked protein groups;
ranking the pharmacologically linked protein groups based on an aggregated biological activity score; and
producing, from the ranked pharmacologically linked protein groups, a protein target/anti-target biologic activity model, where the protein target/anti-target biologic activity model identifies protein target groups separately from protein anti-target groups, and where engagement of the protein targets promotes a biological activity and engagement of the protein anti-targets impedes the biological activity.

2. The method of claim 1, wherein the protein is selected from the group consisting of hydroxylases, oxidases, peroxidases, oxygenases, dehydrogenases, kinases, reductases, deaminases, phosphatases, peroxidases, proteases, transferases, G-protein coupled receptors (GPCR), ion channels, importer channels, exporter channels, nuclear receptors, topoisomerases, HDAC, bromodomains, demethylases, Cytochrome P450, carboxylases, aldolases, and dehydratases.

3. The method of claim 1, further comprising identifying, at the one or more processing units, a prioritized protein representative for each of the pharmacologically linked protein groups.

4. The method of claim 3, wherein identifying the prioritized protein representative for each of the pharmacologically linked protein groups comprises identifying for each of the pharmacologically linked protein groups a protein, within the group, that results in the greatest amount of biological activity when engaged.

5. The method of claim 3, wherein identifying the prioritized protein representative for each of the pharmacologically linked protein groups comprises identifying, for each group, a protein, within the group, linked to the largest number of target proteins in the group, when expressed.

6. The method of claim 3, wherein identifying the prioritized protein representative for each of the pharmacologically linked protein groups comprises;
determining, for each group, an inhibition bias metric for each protein in the group, where a positive inhibition bias metric value indicates that a corresponding protein is a candidate target and a negative inhibition bias metric value indicates that a corresponding protein is a candidate anti-target; and
identifying, for each group, the protein with the largest inhibition bias metric.

7. The method of claim 6, wherein the inhibition bias metric is an average.

8. The method of claim 6, wherein identifying the pharmacologically linked protein groups comprises:
ranking the precision set of protein groups based on an averaged inhibition bias metric for each group.

9. The method of claim 1, wherein identifying the subset of proteins from the set of proteins comprises:
applying a maximum relevance algorithm to the set of proteins and determining the subset of proteins, wherein the proteins in the subset of proteins are either target proteins or anti-target proteins;
identifying, using a machine learning algorithm, a minimum set of proteins satisfying a prediction threshold as the subset of proteins; and
using the compiled output to calculate a biological activity score for each protein.

10. The method of claim 9, wherein the machine learning algorithm is a support vector machine algorithm, decision tree algorithm, association rule, artificial neural network, deep learning algorithm, inductive logic algorithm, clustering algorithm, Bayesian network, reinforcement learning algorithm, representation learning algorithm, similarity and metric learning algorithm, sparse dictionary learning algorithm, genetic algorithm, rule-based machine learning, or learning classifier systems algorithm.

11. The method of claim 9, wherein the machine learning algorithm is supervised or unsupervised.

12. The method of claim 1, wherein identifying (i) the first subset of compounds that form the active compound class, and (ii) the second subset of compounds that form the inactive compound class, comprises:
comparing the received biologic data on the set testing compounds against a threshold amount of biological activity;
identifying compounds resulting in an amount of biological activity above the threshold;
identifying compounds resulting in an amount of biological activity below the threshold; and
applying an assurance stratification algorithm to produce (i) as the first subset of compounds a higher assurance set of compounds having the amount of biological activity above the threshold and (ii) as the second subset of compounds a higher assurance set of compounds having the amount of biological activity below the threshold.

13. The method of claim 1, wherein identifying (i) the first subset of compounds that form the active compound class, and (ii) the second subset of compounds that form the inactive compound class, comprises:
Comparing the received biologic data on the set testing compounds against a threshold amount of biological activity in disease cells and disease-free cells;
Calculating the differential biological activity of compounds on disease cells versus disease-free cells;
Identifying compounds resulting in an amount of differential biological activity above the threshold;
Identifying compounds resulting an amount of differential biological activity below the threshold; and
applying an assurance stratification algorithm to produce (i) as the first subset of compounds a higher assurance set of compounds having the amount of differential biological activity above the threshold and (ii) as the second subset of compounds a higher assurance set of compounds having the amount of differential biological activity below the threshold.

14. The method of claim 9, wherein calculating the differential biological activity of a compound is a function of the area under the dose response curve and the maximal effect size in the cell-based assay.

15. The method of claim 1, further comprising producing the protein target/anti-target biologic activity model as a matrix displaying a single representative of each of the precision set of target and anti-target protein groups.

16. The method of claim 1, where clustering the subset of proteins to form pharmacologically linked protein groups comprises;
performing a pairwise sequence alignment analysis on the subset of proteins using amino acid sequence data;
performing a pairwise pharmacology interaction strength analysis on the subset of proteins using biochemical activity data; and
clustering proteins that correspond to a given threshold for (i) pairwise sequence alignment and/or (ii) pairwise pharmacology interaction strength.

17. The method of claim 1, wherein the biologic activity is a decrease in cell proliferation, such that engaging target proteins decrease cell proliferation and engaging anti-target proteins increase cell proliferation.

18. The method of claim 17, wherein the biologic activity is a decrease in cancer cell proliferation.

19. The method of claim 1, wherein the biologic activity is a decrease in cell proliferation, such that engaging target proteins induces cell death and engaging anti-target proteins prevents cell death.

20. The method of claim 1, wherein the biologic activity is a decrease in cell proliferation, such that engaging target proteins prevents cell death and engaging anti-target proteins induces cell death.

21. The method of claim 1, wherein the biologic activity is viability/cytotoxicity/apoptosis, 2D growth (cell mass), 3D growth (spheroid size), migration, invasion, autophagy, cell cycle arrest, or surface marker expression.

22. The method of claim 17, wherein the biologic activity changes over time.

23. The method of claim 22, wherein the biologic activity changes over time from cell death to cell proliferation or vice versa.

24. The method of claim 17, wherein the biologic activity comprises a plurality of biologic activities.

25. The method of claim 1, wherein the protein target/anti-target biologic activity model is a protein target/protein anti-target matrix.

26. The method of claim 25, further comprising:
receiving data on a second set of testing compounds;
comparing the data on the second set of testing compounds to the protein target/anti-target matrix; and
identifying, using the protein target/anti-target matrix, one or more compounds of the second set of compounds as engaging one or more of the pharmacologically linked protein groups.

27. The method of claim 26, further comprising:
identifying, using the protein target/anti-target matrix, a set of compounds of the second set of compounds each expressing one or more representatives of the target protein groups; and
identifying, from the set of compounds, the compound expressing the largest number of representatives of target groups and none of the representatives of anti-target groups as a treatment compound for treating a pathology.
